(19) United States
(12) Patent Application Publication
(10) Pub. No.: US 2009/0152970 A1
(43) Pub. Date: Jun. 18, 2009

(54) POWER GENERATOR USING PERMANENT MAGNET

(76) Inventor: Jeong Yong Lee, Gyeonggi-do (KR)

Correspondence Address: IPLA P.A., 3580 WILSHIRE BLVD., 17TH FLOOR, LOS ANGELES, CA, 90010, US

(21) Appl. No.: 11/721,305

(22) PCT Filed: Dec. 8, 2005
(86) PCT No.: PCT/KR2005/004202

§ 371 Date: Jun. 8, 2007

(30) Foreign Application Priority Data
Dec. 9, 2004 (KR) 10-2004-0103689

(51) Int. Cl. H02K 21/00; H02N 11/00

(52) U.S. Cl. 310/152; 415/916

(57) ABSTRACT

A power generator using a permanent magnet is provided, which includes a fan having a magnetic property of generating a repulsive force when identical polarities approach between magnetic bodies, and a permanent magnet plate which is located in opposition to one side of the fan and axially combined with the fan on an identical shaft. In this case, the polarity of one surface of the fan equals that of the facing surface of the permanent magnet plate facing the fan. Thus, since a repulsive force is generated between the fan and the permanent magnet plate, the fan continuously rotates to thereby generate power.

### TECHNICAL FIELD

The present invention relates to a driving apparatus using power, for example, a power generator using a permanent magnet which is mounted on an electric generator or vehicle to supply power required for the driving apparatus, and more particularly to, a power generator using a permanent magnet in which a fan permanently rotates without having a separate driving apparatus such as a motor by use of a repulsive force which is generated when identical polarities approach between magnetic bodies, and thus necessary power can be obtained by rotation of the rotating fan.

### BACKGROUND ART

In general, a power generator includes a fan which is a rotating body, and a motor or engine for making the fan rotate. The fan which is a rotating body rotates by rotation of the motor, and then power which is obtained by rotation of the fan is applied to an electric generator or other driving apparatuses.

As described above, the conventional power generators should drive a motor or engine in order to generate power. As a result, an additional energy source such as electric power or gasoline or light oil should be supplied to drive the motor or engine.

Thus, much cost consumed for supplying electric power or gasoline or light oil causes economical burden to users.

Accordingly, power generators which can generate power using natural environment such as a hydraulic power generator or wind power generator have been used, but such power generators using natural environment cannot be used in general industrial fields unless geographical conditions are met.

### DISCLOSURE OF THE INVENTION

To solve the above problems, it is an object of the present invention to provide a power generator using a permanent magnet which includes a fan having a magnetic property of generating a repulsive force when identical polarities approach between magnetic bodies, and a permanent magnet plate which is located in opposition to one side of the fan and axially combined with the fan on an identical shaft, in which case the polarity of one surface of the fan equals that of the facing surface of the permanent magnet plate facing the fan, and thus since a repulsive force is generated between the fan and the permanent magnet plate, the fan continuously rotates to thereby generate power.

To accomplish the above object of the present invention, according to an aspect of the present invention, there is provided a power generator using a permanent magnet, the power generator comprising: a fan; and a first permanent magnet plate facing the fan, wherein the fan is formed of a number of fan blades each of which is made of a permanent magnet whose both surfaces possess respectively different magnetic polarities, wherein the first permanent magnet plate is axially combined with one side of the fan, and wherein one surface of the first permanent magnet plate having the same polarity as that of one surface of each fan blade is located in opposition to the facing surface of each fan blade.

Preferably, the power generator using a permanent magnet further comprises a second permanent magnet plate whose one surface facing the other surface of each fan blade has the opposite polarity to that of the one surface of each fan blade.

Preferably, the fan is combined on the central shaft penetrating the centers of the fan and the first permanent magnet plate with the first permanent magnet plate which is combined facing one side of each fan blade and whose one side has the same polarity as that of the one side of each fan blade and other side has the opposite polarity as that of the one side of each fan blade.

Preferably, an adjustment screw is further formed at the end of the first permanent magnet plate in order to adjust distance between the fan and the first permanent magnet plate.

Preferably, magnet bearings are further combined between the central portion of the fan and the central shaft combined with the central portion of the fan.

Accordingly, the power generator using a permanent magnet enables the fan to rotate consistently according to a repulsive force generated between identical polarities of a permanent magnet plate and fan blades made of permanent magnet materials without having a separate driving apparatus, to thereby obtain power by the rotating force of the rotating fan.

### BRIEF DESCRIPTION OF THE DRAWINGS

The above and other objects and advantages of the present invention will become more apparent by describing the preferred embodiments thereof in detail with reference to the accompanying drawings in which:

FIG. 1 is a perspective view showing a power generator using a permanent magnet according to an embodiment of the present invention;

FIG. 2 is a perspective view showing a power generator using a permanent magnet according to another embodiment of the present invention; and

FIG. 3 is a cross-sectional view showing a central portion of the fan in the power generator using a permanent magnet according to the present invention.

### BEST MODE FOR CARRYING OUT THE INVENTION

Hereinbelow, a power generator using a permanent magnet according to the present invention will be described with reference to the accompanying drawings.

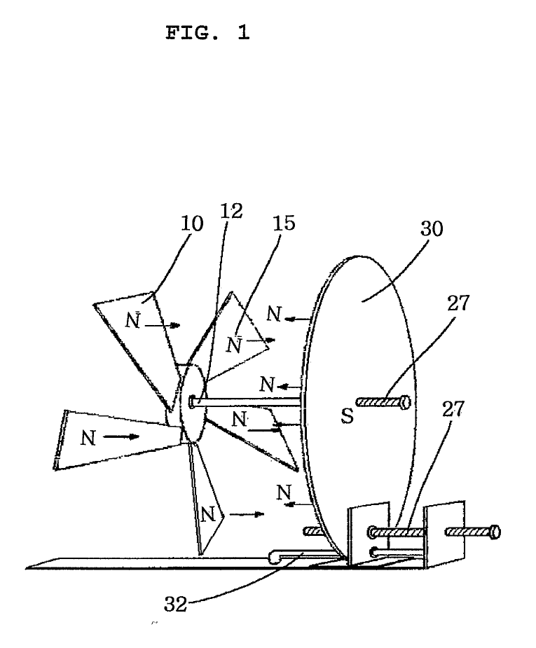

Referring to FIG. 1, a power generator using a permanent magnet includes a fan 10 and a first permanent magnet plate 30 facing the fan 10. The fan 10 is formed of a number of fan blades 15 each of which is made of a permanent magnet whose both surfaces possess respectively different magnetic polarities. Also, the first permanent magnet plate 30 is axially combined with the fan 10, via a central shaft 12, and one surface of the first permanent magnet plate 30 having the same polarity as that of one surface of each fan blade 15 is located in opposition to the facing surface of each fan blade 15.

Thus, assuming that each fan blade 15 in the fan 10 exhibits the polarity of an N=pole, the front surface of the first permanent magnet plate 30 facing the fan 10 exhibits the polarity of an N-pole, and the rear surface thereof exhibits the polarity of an S-pole. Accordingly, since a repulsive force is generated between each fan blade 15 and the first permanent magnet plate 30, the fan 10 is made to rotate. As a result, power is obtained by the rotating force of the fan 10.

Further, an adjustment screw 27 is formed at the end of the central shaft 12 penetrating the first permanent magnet plate 30 at the center 20 of the first permanent magnet plate 30, in order to adjust distance between the fan 10 and the first permanent magnet plate 30.

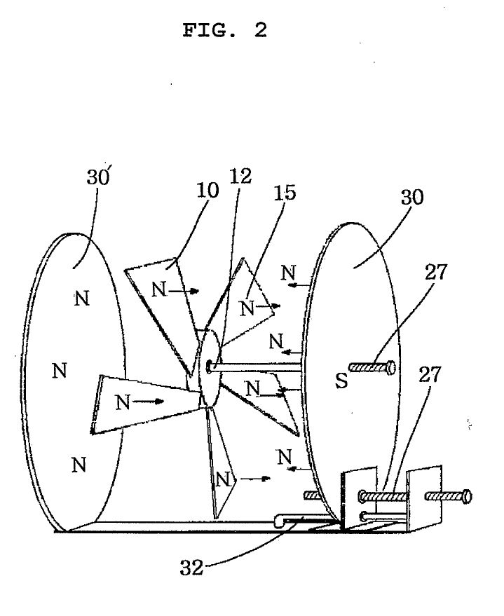

Also, referring to FIG. 2, a power generator according to another embodiment of the present invention further includes a second permanent magnet plate 30′ whose one surface facing the other surface of each fan blade 15 has the opposite polarity to that of the one surface of each fan blade 15. Accordingly, the fan 10 may rotate more reliably.

Meanwhile, the fan 10 is combined on a central shaft 12 penetrating the centers of the fan 10 and the first permanent magnet plate 30, with the first permanent magnet plate 30 which is combined facing one side of each fan blade 15 and whose one side has the same polarity as that of the one side of each fan blade 15 and other side has the opposite polarity as that of the one side of each fan blade 15.

In FIG. 2, the first permanent magnet plate 30 is combined with the fan 10 via the central shaft 12, but the second permanent magnet plate 30′ is not combined with the fan 10. However, the second permanent magnet plate 30′ may be combined with the fan 10 via an extended central shaft 12 penetrating the fan 10. In this case, the fan 10 can rotate consistently by the repulsive forces between the fan 10 and each permanent magnet plates 30 and 30′.

As in the FIG. 1 embodiment of the present invention, an adjustment screw 27 is formed at the end of the central shaft 12 penetrating the first permanent magnet plate 30 at the center of the first permanent magnet plate 30, in order to adjust distance between the fan 10 and the first permanent magnet plate 30.

Further, in addition to an adjustment screw 27 formed at the end of the central shaft 12 penetrating the first permanent magnet plate 30 at the center of the first permanent magnet plate 30, an adjustment screw 27′ is formed at the lower end of the first permanent magnet plate 30 via at least one support rod 32 in order to adjust distance between the fan 10 and the first permanent magnet plate 30. Here, it is preferable that the permanent magnet plate 30 may be slid on the support rod 32.

As being the case, the distance between the fan 10 and the second permanent magnet plate 30′ may be adjusted in the same manner as that of the fan 10 and the first permanent magnet plate 30.

Thus, since the distance between the fan 10 and each permanent magnet plate 30 or 30′ can be adjusted by the adjustment screw 27 or 27′, the repulsive force between the fan 10 and each permanent magnet plate 30 or 30′ can be adjusted at a desired degree. That is, the rotating force of the fan 10 can be adjusted.

For example, as the distance between the permanent magnet plate 30 or 30′ and the fan 10 becomes far, the repulsive force generated between them becomes small. Meanwhile, as the distance between the permanent magnet plate 30 or 30′ and the fan 10 becomes near, the repulsive force generated between them becomes large. In this manner, the rotating force of the fan 10 can be adjusted.

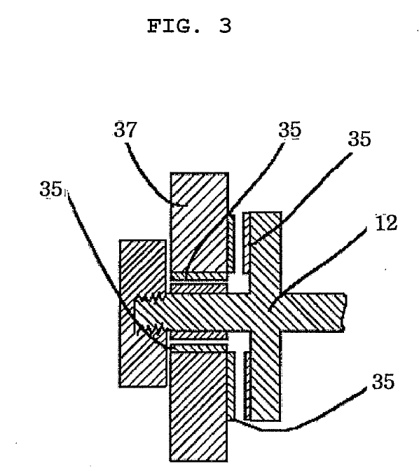

Referring to FIG. 3, magnet bearings 35 are further combined between the central portion of the fan 10 and the central shaft 12 combined with the central portion of the fan 10, in order to reinforce the repulsive force between the fan 10 and the permanent magnet 30 or 30′ as well as smoothen rotation of the fan 10.

Accordingly, the power generator using a permanent magnet enables the fan to rotate consistently according to a repulsive force generated between identical polarities of a permanent magnet plate and fan blades made of permanent magnet materials without having a separate driving apparatus, to thereby obtain power by the rotating force of the rotating fan.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, the present invention provides a power generator using a permanent magnet in which a fan permanently rotates without having a separate driving apparatus such as a motor by use of a repulsive force which is generated when identical polarities approach between magnetic bodies, and thus necessary power can be obtained by rotation of the rotating fan.

1. A power generator using a permanent magnet, the power generator comprising:
a fan; and
a first permanent magnet plate facing the fan,
wherein the fan is formed of a number of fan blades each of which is made of a permanent magnet whose both surfaces possess respectively different magnetic polarities,
wherein the first permanent magnet plate is axially combined with the fan, and
wherein one surface of the first permanent magnet plate having the same polarity as that of one surface of each fan blade is located in opposition to the facing surface of each fan blade.

2. The power generator using a permanent magnet according to claim 1, further comprising a second permanent magnet plate whose one surface facing the other surface of each fan blade has the opposite polarity to that of the one surface of each fan blade.

3. The power generator using a permanent magnet according to claim 1, wherein the fan is combined on a central shaft penetrating the centers of the fan and the first permanent magnet plate, with the first permanent magnet plate which is combined facing one side of each fan blade and whose one side has the same polarity as that of the one side of each fan blade and other side has the opposite polarity as that of the one side of each fan blade.

4. The power generator using a permanent magnet according to claim 1, wherein an adjustment screw is further formed at the end of the first permanent magnet plate in order to adjust distance between the fan and the first permanent magnet plate.

5. The power generator using a permanent magnet according to claim 1, wherein magnet bearings are further combined between the central portion of the fan and the central shaft combined with the central portion of the fan.
